(19) United States
(12) Patent Application Publication
(10) Pub. No.: US 2026/0191129 A1
(43) Pub. Date: Jul. 9, 2026

(54) Remote Controlled Chassis for Any Lawn Mower

(71) Applicant: Calen T McCann, Deltona, FL (US)

(72) Inventor: Calen T McCann, Deltona, FL (US)

(21) Appl. No.: 19/015,140

(22) Filed: Jan. 9, 2025

(51) Int. Cl. A01D 34/00; A01D 34/81; A01D 101/00

(52) U.S. Cl. CPC A01D 34/008; A01D 34/81; A01D 2101/00

(57) ABSTRACT

This invention is a modular remote-controlled chassis that converts any standard push mower into a remote-controlled mower. It features a two-piece adjustable frame of square tubing and flat bars, allowing compatibility with various mower sizes. A four-piece mower mounting system ensures secure attachment while preserving deck adjustments. A fail-safe safety adapter triggers the mower's safety switch, lever, or button and is universally adaptable via a detachable connector. The system supports upgradable four-wheel drive by connecting motors in parallel with a Y-splitter. The electronic box houses key components, including a motor driver, microcontroller, power switch, and an airflow system with intake and exhaust fans for cooling. A unique connector system prevents installation errors and allows future upgrades. Designed for durability and adaptability, this chassis provides a safe, efficient solution for converting push mowers into remote-controlled units.

### CROSS-REFERENCE TO RELATED APPLICATIONS

The present application relates to U.S. Pat. No. 11,483,967, entitled “Method of Conversion to Automated Lawn Mower,” which describes a frame attachment for converting a standard push lawn mower into an automated device. However, this application is distinct and differs significantly in both design and implementation from the referenced patent for the following reasons:

Vague Description and Drawings in U.S. Pat. No. 11,483,967

The referenced patent's description and drawings lack specificity, making it unclear how the claimed methods and features are implemented. The drawings do not adequately illustrate the structure or operation of the frame attachment, nor do they provide a clear depiction of how the frame is mounted to the mower. The description merely states that “a frame attachment mounts the lawn mower” without elaborating on the method or mechanism used for attachment, which leaves substantial ambiguity.

### Distinctive Features and Design of the Present Application

The present invention introduces a comprehensive, detailed, and fully functional design utilizing a single piece of square tubing as the primary structural element of the chassis. Unlike the referenced patent, which mentions a “frame” without specification, this application provides a thorough and explicit description of the design, including detailed mechanisms for mounting and adjusting the frame. Additionally, the present invention employs a simplified and innovative mounting system that is both efficient and highly adaptable, diverging entirely from the unspecified “frame attachment” approach of the referenced patent.

### Standardized Feature of Mounting the Frame to Mower Wheels

Both inventions involve attaching the frame at the mower's existing wheel positions, which inherently adjusts the deck. This feature is a standard and functional aspect of mounting any object to a push mower. As such, it does not qualify as a patentable feature due to its generic nature and lack of novelty. This principle aligns with MPEP § 2141.01 (a), which requires claims to exhibit sufficient novelty and non-obviousness in their implementation. The referenced patent neither claims nor demonstrates how the mounting is achieved in a novel manner. Also, the feature of adjusting the deck comes already built into the push mower by a built-in mechanism by the mower's manufacturer, not by any attachment.

### Unique Implementation of the Present Invention

The present invention utilizes square tubing as the primary structural element of the frame, a design choice not specified or claimed in the referenced patent. Square tubing, being a standard material in mechanical applications, is not patentable as a standalone feature; however, its use in this invention provides a straightforward, durable, and efficient means of constructing the chassis. The referenced patent does not claim or describe the use of square tubing or any similar specific structural components.

### Legal Basis Supporting Novelty and Non-Obviousness

As per MPEP § 2163 and MPEP § 2164, functional limitations in claims must be supported by a clear and specific description. The referenced patent does not meet this requirement, as its description fails to explain how the frame attachment operates or how it mounts to the mower and frame. The current application overcomes these deficiencies by providing a thorough and detailed explanation of its structure and functionality.

In Addition, this is why the Reference Patent Fails to Meet the Required Standards:

### Claim Insufficient Detail:

Reference MPEP § 2163 and argue that the cited patent does not include sufficient detail to demonstrate the inventor's possession of the claimed invention.

### Claim Non-Enablement:

Reference MPEP § 2164 and 2164.01 (a), emphasizing that the cited patent does not provide enough information or logical reasoning to enable a person skilled in the art to reproduce the invention without undue experimentation.

### Compare to Prior Art:

Argue that the cited patent fails to distinguish itself from the prior art because it does not explain how it achieves its claimed functionality, thus making it unclear whether it constitutes a true advancement.

### Distinctions in Mower Operation

The referenced patent (U.S. Pat. No. 11,483,967) does not provide any description or explanation of how the push mower will operate, enable, or turn on when attached to the frame with wheels. Specifically, the referenced patent fails to address a critical aspect of mower operation: the activation of the safety lever (bail bar), which must be continuously engaged for any push mower to start and function. This omission leaves a fundamental gap in its claims regarding the operability of the mower when attached to the frame. In contrast, the present invention thoroughly addresses this operational requirement. As illustrated in FIG. 1 and FIG. 2 of this application, the design includes a specific mechanism that ensures the safety lever is securely held in place during operation. This critical feature ensures that the mower remains enabled and cutting the grass when attached to the chassis, allowing for seamless remote-control operation.

NOTE: An Additional Key Difference Between this Invention Vs. The Referenced Invention is the Following:
The referenced invention is a method to convert a push mower to an automated mower (while automated is self-driven, not remote controlled). My invention differs as it is not automated, but remote controlled where it needs an end user to control the application remotely.
The referenced invention lacks detail on the operation as per MPEP § 2164.01 and MPEP § 2164.01 (c)). Although it provides a basic description of the design, it does not describe what all parts of the invention do and how they are to be achieved. Example: they did not describe how the mower will turn on, which is essential in operation. Without this detail, the invention is incomplete. As per MPEP § 2164.01 and MPEP § 2164.01 (c)), This does not allow someone skilled in the art to make and use the invention nor instructions for the end user are necessary for making or using the invention. Without this detail, the invention is incomplete. However, my invention covers this with thorough detail.
My invention is a method to include all parts needed for assembly as a kit for the end user to assemble onto their existing push lawn mower.

### REFERENCES

MPEP § 2141.01 (a): Evaluating obviousness of features that are common practice or standard in the art.
MPEP § 2163 and MPEP § 2164: Requiring specific and functional limitations in claims to distinguish an invention.
MPEP § 2164: Enablement Requirement
MPEP § 2164.01 (c)—Guidance on End-User Operation
MPEP § 2173.05 (e)—Lack of Antecedent Basis or Deficient claims

### BACKGROUND OF THE INVENTION

The present invention relates to remote control chassis systems and, more particularly, to an adaptable frame that can convert standard push lawn mowers into remote-controlled devices. Existing designs for automated mowers often require dedicated, built-in systems, limiting adaptability and increasing costs. There is a need for a versatile chassis that accommodates various mower types while remaining affordable and easy to use.

### SUMMARY OF THE INVENTION

The invention provides a universal remote-control chassis designed to attach to existing push lawn mowers. The chassis includes adjustable mounting brackets and a control system to remotely operate the mower. This design reduces costs and enhances accessibility compared to fully integrated automated mowers.

### BRIEF DESCRIPTION OF THE DRAWINGS

These drawings can be better understood by reading the descriptions in-line with the corresponding pointer towards the drawing. Note: drawings are not to scale and frame may be slightly different. (i.e. the flat bar may be facing in another direction such as upwards or flat)

FIG. 1: Perspective view of the chassis attached to a lawn mower. Also includes safety features such as the clamp/impact system which enables the mower when safe and disables all systems as failsafe when/if a safety concern occurs. (2-wheel drive option)

FIG. 2: Perspective view of the chassis attached to a lawn mower. (4-wheel drive option)

FIG. 3: Expanded view of the remote-controlled chassis with details of all parts.

FIG. 4: Attachment system for optional 4-wheel drive add-on.

FIG. 5: Detached view and method to connect the wires and 4-wheel drive connections explained.

FIG. 6: Assembled view of the chassis with all add-ons/attachments minus the push mower.

### DETAILED DESCRIPTION OF THE INVENTION

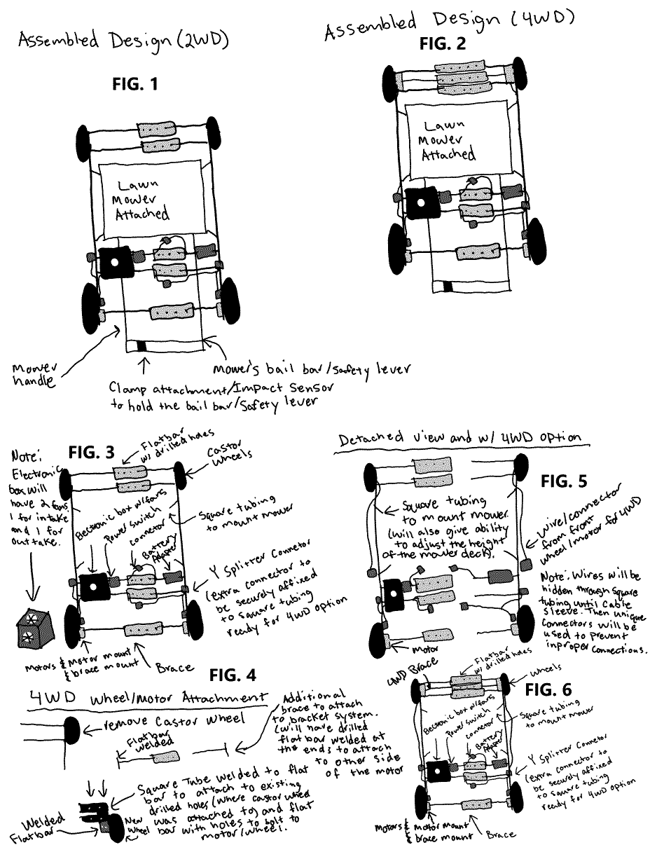

### FIG. 1:

This drawing provides a perspective view of the remote-controlled chassis mounted to a lawn mower, with all components fully assembled. Highlighted in this figure is a safety attachment that functions as both a clamp and a fail-safe mechanism. This attachment mounts directly onto the handle of the push mower and secures the mower's safety lever (bail bar), which must be engaged for operation. The clamp also includes an integrated sensor to monitor impact vibrations and/or proximity, preventing collisions. If the sensor is triggered due to a safety concern, the clamp releases the bail bar, effectively shutting down both the remote-controlled chassis and the mower. This attachment is connected via a specialized connector from the electronic box.

### FIG. 2:

This figure illustrates the same chassis design with an additional 4-wheel drive attachment. It features an extra brace for securing the added motors and wheels, ensuring stability during operation.

### FIG. 3:

This figure provides a detailed breakdown of the chassis, showcasing how its various components work together. The chassis frame consists of square tubing and flat bar, designed in two separate parts for convenient assembly (a left side and a right side).
The left side features a longer piece of square tubing welded to two shorter pieces of square tubing at the front, which support the front wheel. These front square tubing sections are connected to a flat bar with pre-drilled holes to secure the wheel assembly. Similarly, the rear section features square tubing welded to the long piece, which is also connected to a flat bar with pre-drilled holes for attachment. The electronic box, located further along the frame, houses components like the motor driver, a microcontroller with features for various operations, an airflow system with intake and exhaust fans, and a power switch. All wires are enclosed in a cable sleeve for proper cable management.
Further back, toward the end of the frame, are the wheels and motors. These are mounted on a motor/wheel bracket, which is connected to a brace made of square tubing. The brace, in turn, is connected to the flat bar. The square tubing and flat bar configuration provides a secure mounting structure for the wheels and motors at the rear. On the right side, the frame mirrors the left side, featuring square tubing with pre-drilled holes, but it does not include a flat bar. The square tubing is used to maintain structural integrity, and the connection is made in the same way as the adjustable system for the left side.
The right side also includes a battery connector for easily attaching and detaching the recommended battery, and a Y-splitter is mounted to facilitate the optional 4 wheel-drive system, enabling front and back motors to operate in parallel for synchronized movement. Both sides of the chassis are connected by aligning the pre-drilled holes in the square tubing from the right side with those on the flat bar from the left side, making the frame adjustable to fit various lawnmowers.

### FIG. 4:

This figure demonstrates the method for replacing the caster wheels with the 4-wheel drive system. It includes detailed views of the motor/wheel braces, showing pre-drilled holes for bolting the components securely together.

### FIG. 5:

This detached view provides a clear breakdown of the assembly process:
The mower's original wheels are removed, and the chassis is mounted to the mower's wheel axles using square tubing brackets. Each bracket has two holes: one for attaching to the mower's wheel axle and the other for connecting to the frame's pre-drilled holes. This system allows the mower's original cutting deck adjustment feature to remain functional.
The left and right frame sections are joined by aligning pre-drilled holes on the flat bar (from the left frame) with holes on the square tubing (from the right frame). The connection is secured using bolts, enabling frame adjustability to accommodate different mower sizes.
Wiring from the back motor is connected to the Y-splitter, ensuring that the front and back wheels move simultaneously and in the same direction. This maintains the mower's zero-turn radius for precise and smooth turning.
Each connector in the system is uniquely keyed to prevent improper installation.

### FIG. 6:

This drawing shows the fully assembled chassis with the 4-wheel drive add-on and additional braces installed.

1. A remote-controlled chassis for a lawn mower, that can be sold as a kit for the end-user to assemble, comprising:
a. A two-piece adjustable frame design featuring square tubing and flat bars, allowing for structural flexibility and customization.
b. A mower mounting system utilizing four pieces of square tubing: two at the front and two at the rear, each equipped with pre-drilled holes to secure the mower and ensure compatibility with various push mower designs, enabling the conversion of any push mower into a remote-controlled lawn mower.

2. The chassis of claim 1, wherein the frame is adaptable for upgrades, including the ability to convert from a two-wheel drive to a four-wheel drive system by connecting two motors in parallel using a Y-splitter, providing enhanced functionality and performance.

3. An electronic box mounted on the chassis, comprising: a. A built-in airflow system with an intake fan and an exhaust fan to regulate temperature and ensure the safe operation of electronic components. b. A power switch for centralized control of the system.

4. The chassis of claim 1, further comprising a unique connector system for safely making all electrical connections, including: a. Distinct connectors for the battery adapter, motors, and safety mechanisms, designed for easy identification and replacement. b. Adaptability to support future accessories or replacement parts by ensuring connector diversity and compatibility.

5. A mechanism for engaging the safety switches, levers, or buttons required to start the lawn mower, comprising: a. A detachable connector from the electronic box to interface with the mower's safety mechanism. b. Adaptability to accommodate various safety mechanisms used in other mower designs, ensuring compatibility with different mower models.

6. The chassis of claim 5, further comprising a fail-safe mechanism as part of the safety switch engagement system, ensuring that the mower and the remote-control chassis do not operate unless the safety mechanism is properly triggered.

7. The method of claim 4, wherein the connector system allows seamless detachment and reattachment for adaptability to other safety adapters, enabling the system to work with different mower models and configurations without compromising safety.

8. A lawn mower mounting system as described in claim 1, wherein the design and structure support mounting with an adjustable and secure connection, ensuring stability during operation and ease of integration with different mower sizes.

9. A remote-controlled chassis for a lawn mower, as described in claim 1, wherein all components are modular, allowing for customizable configurations, replacement, and future upgrades without compromising the structural integrity of the design.

10. A system and method as described in claim 1, specifically designed to convert any standard push mower into a fully functional remote-controlled lawn mower, while retaining the original functionality of the mower's cutting deck adjustment and ensuring compatibility with various push mower models.
